(19) United States
(12) Patent Application Publication
(10) Pub. No.: US 2013/0299203 A1
(43) Pub. Date: Nov. 14, 2013

(54) VEHICLE FIRE RISK REDUCING SYSTEM

(71) Applicant: Akhmad Turaev, Flushing, NY (US)

(72) Inventor: Akhmad Turaev, Flushing, NY (US)

(21) Appl. No.: 13/466,820

(22) Filed: May 8, 2012

(51) Int. Cl. A62C 3/07; A62C 37/38

(52) U.S. Cl. 169/60; 169/62

(57) ABSTRACT

A vehicle fire risk reducing system has a vehicle with a plurality of vehicle components, and a fire extinguishing device which can be operated by a user to prevent fire or to extinguish fire, or can operate automatically in response to signals from sensors provided in the vehicle and sending signals about an unacceptably elevated temperature or a fire in the vehicle, at least In an area of a vehicle engine under a vehicle hood.

### SUMMARY OF THE INVENTION

Accordingly, it is an object of the present invention to provide a vehicle fire risk reducing system, which is a further improvement of the existing systems.

In keeping with this object and with others which will become apparent hereinafter, one feature of the present invention resides, briefly stated, in a vehicle system which includes a vehicle with vehicle components, and a fire extinguishing device capable of

acting on a fire generated in the vehicle so as at least significantly extinguish the

fire.

In accordance with further features of the present invention, the fire extinguishing device can be operatable by a vehicle occupant or by another person, to direct a fire extinguishing substance on the fire.

In accordance with a further feature of the present invention, the vehicle is provided with sensing means which sense an elevated temperature in the vehicle, leading to a fire or associated with already starting fire, and sends a signal to the fire extinguishing device, which, in response to the signal, releases the fire extinguishing substance.

In accordance with a further feature of the present invention, the sensing means include a plurality of sensors arranged at different locations of the vehicle, and the fire extinguishing device directs the fire extinguishing substance to a location of a sensor, which sends a signal to the device.

A still further feature of the present invention is that the fire extinguishing device is located in an inner space of the vehicle and can be operated to extinguish the fire in the vehicle inner space.

Still a further feature of the present invention is that the sensing means include a plurality of sensors provided at locations selected from the group consisting of near an engine, near a fuel tank, near a pipe which supplies fuel from the fuel tank to the engine, in an inner space of the vehicle, outside of the inner space, and combinations thereof.

In accordance with a further feature of the present invention, the fire extinguishing device has fire extinguishing elements located so as to direct a fire extinguishing substance to the locations wherein the sensors are located.

The novel features of the present invention are set forth in particular in the appended claims. The invention itself however will be best understood from the following description of the preferred embodiments which is accompanied by the following drawings.

### BRIEF DESCRIPTION OF THE DRAWINGS

FIG. 1 is a view schematically showing a vehicle with its vehicle components and a fire extinguishing device in accordance with the present invention;

FIG. 2 is a view schematically showing components of an inventive vehicle fire risk reducing system;

FIG. 3 is a view schematically showing further components of the inventive vehicle fire risk reducing system; and

FIG. 4 is a view showing an additional improvement of the system in accordance with the present invention.

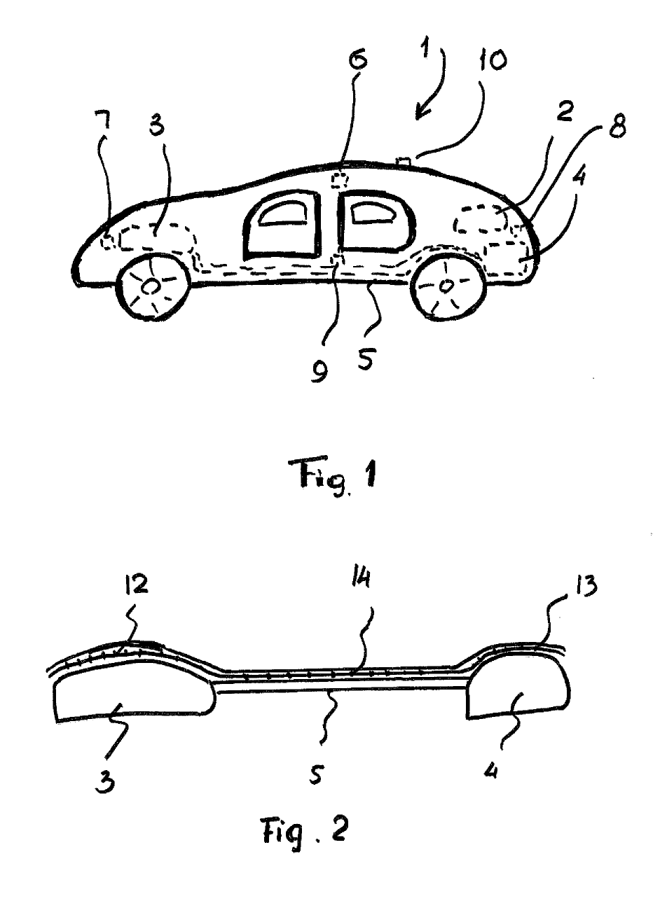

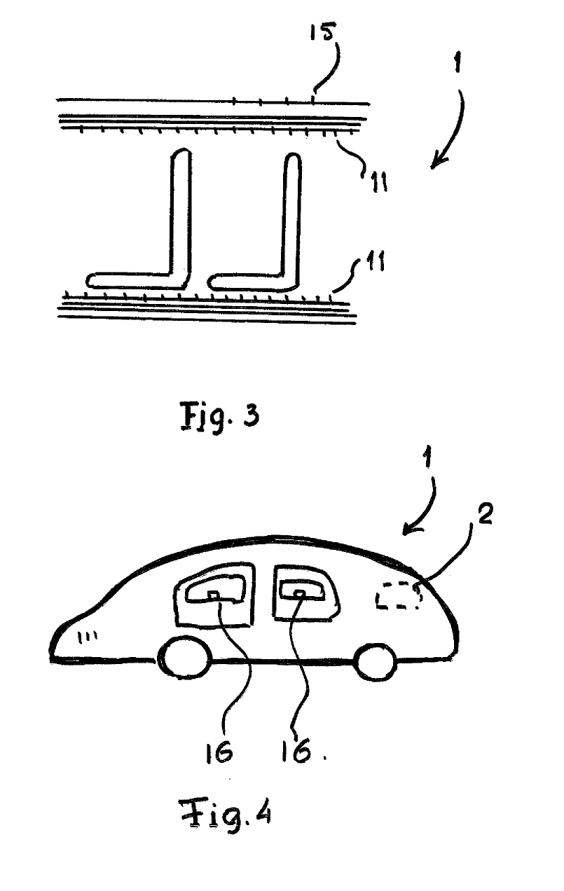

### DESCRIPTION OF THE PREFERRED EMBODIMENTS

A vehicle fire risk reducing system in accordance with the present invention includes a vehicle which is identified as a whole with reference numeral 1 and has vehicle components.

A fire extinguishing device identified with reference numeral 2 is provided in the vehicle 1. When a temperature in the vehicle raises to a level which can cause fire or when a fire starts, the fire extinguishing device can direct a fire extinguishing substance to a corresponding location.

The vehicle 1 can have a motor 3 which can be of any type, but also can be an internal combustion engine which is supplied with a fuel from a fuel tank 4 through a fuel supplying pipe 5.

In the invention system the fire extinguishing device can be formed as a conventional fire extinguisher, which can be removed from its place by a vehicle occupant or another person, activated, and directed to a location of the vehicle, where the temperature is elevated and approaches a temperature which can cause fire, or directed straight to a starting fire, so that the extinguishing substance is directed towards the above mentioned locations to prevent occurrence of fire or to extinguish it.

In the inventive system the fire extinguishing device can also operate automatically. For this purpose a plurality of sensors can be provided at different locations of the vehicle 1 and can include an inner space sensor 6, an engine sensor 7, a fuel tank sensor 8, a fuel supplying pipe sensor 9, an outer space sensor 10 associated for example with a vehicle roof, and various combinations of these sensors.

The fire extinguishing device 2 in turn can communicate with fire extinguishing elements including inner space sprinklers 11, engine sprinklers 12, fuel tank sprinklers 13, fuel supplying pipe sprinklers 14, outer space sprinklers associated for example with the vehicle roof, and various combinations of these sprinklers. The sprinklers can be formed as openings or nozzles provided in the pipes which communicate with the fire extinguishing device 2 and supply the fire extinguishing substance to the corresponding openings or nozzles to exit to corresponding locations of the vehicle, so as to cools the locations or to extinguish the fires at these locations.

In accordance with the present invention the fire extinguishing device can supply the fire extinguishing substance to all such locations, or alternatively it can supply the fire extinguishing substance only to the location or locations, where the sensor or sensors sense the elevated temperature or the temperature corresponding to the fire at each particular location or locations and send corresponding signals to the fire extinguishing device.

It is known that in some instances excessive damage to a person's health and even death can be caused by smoke which accompanies the fire. In accordance with the present invention the inventive system is provided with window glass lowering elements 16, which can be formed for example as units, that in response to sensing fire by corresponding sensors, cause lowering of window glass of the windows of the vehicle 1. This allows a fresh air enter the inner space of the vehicle 1 to prevent damaging smoke action on car occupants, and it also allows occupants to escape through the windows.

It is to be understood that the main feature of the present Invention is the means and the step of preventing or extinguishing fires under the hood of the vehicle, in the area of the engine, which the additional means and steps supplementary contribute to the fire preventing and fire extinguishing. The source of the fire extinguishing substance can be located directly under the hood.

The invention is not limited to the details shown since various modifications and structural changes are possible without departing from the spirit of the present invention.

What is desired to be protected by Letters Patent is set forth in particular in the appended claims:

1. A vehicle fire risk reducing system, comprising a vehicle with vehicle components, and a fire extinguishing device acting on a fire generated in said vehicle and at least significantly extinguishing the fire in said vehicle at least in an area of a vehicle engine under a vehicle hood.

2. A vehicle fire risk reducing system as defined in claim 1, wherein said fire extinguishing device is operatable by a vehicle occupant or by another person, to direct a fire extinguishing substance toward the fire in the vehicle.

3. A vehicle fire risk reducing system as defined in claim 1, further comprising sensing means which sense an elevated temperature in said vehicle, capable of leading to a fire or associated with already started fire, and send a signal to said fire extinguishing device which, in response to said signal, releases a fire extinguishing substance.

4. A vehicle fire risk reducing system as defined in claim 3, wherein said sensing means include a plurality of sensors arranged at different locations of said vehicle and sending signals to said fire extinguishing device which, in response to said signals, directs the fire extinguishing substance at a location where a sensor that sent a signal about the elevated temperature or about the fire is located.

5. A vehicle fire risk reducing system as defined in claim 1, wherein said first extinguishing device is located in an inner space of said vehicle and is operatable to prevent or extinguish a fire in said inner space of vehicle.

6. A vehicle fire risk reducing system as defined in claim 3, wherein said sensing means include a plurality of sensors located at locations selected from the group consisting of near a vehicle engine, near a fuel tank, near a pipe which supplies fuel from said fuel tank to said engine, in an inner space of said vehicle, outside of said inner space of said vehicle, and combinations thereof.

7. A vehicle fire risk reducing system as defined in claim 6, wherein said fire extinguishing device has fire extinguishing elements located so as to direct a fire extinguishing substance to corresponding locations where said sensors are located.

8. A vehicle fire risk reducing system as defined in claim 1, and further comprising means for automatically breaking a window glass in vehicle windows when a temperature inside an inner space reaches a level which can cause fire or when a fire starts in said vehicle.
